(19) United States
(12) Patent Application Publication
(10) Pub. No.: US 2020/0370736 A1
(43) Pub. Date: Nov. 26, 2020

(54) Simply and Quickly Replaceable LED Panel Light

(71) Applicant: Yichang Jiangjing Optoelectronic Co., Ltd., Yichang City (CN)

(72) Inventors: Ming Tan, Yichang City (CN); Yibo Xu, Yichang City (CN)

(21) Appl. No.: 16/507,018

(22) Filed: Jul. 9, 2019

(30) Foreign Application Priority Data
May 23, 2019 (CN) 201910431160.4

(51) Int. Cl. F21V 21/03; F21V 8/00; F21V 23/02

(52) U.S. Cl. CPC F21V 21/03; G02B 6/0051; F21Y 2103/10; G02B 6/0086; F21V 23/02

(57) ABSTRACT

A simply and quickly replaceable LED panel light including a panel light body and a replaceable frame located below the panel light body. A fixing group is provided between the replaceable frame and the panel light body. The interior of panel light body has a placement cavity. A back plate, an EVA cotton pad, a reflective paper, a light guide plate, and a diffuser plate are, in turn, provided inside the placement cavity from bottom to top. A constant current power supply is fixed at the inner corner of the placement cavity. Two LED lighting modules are provided inside the placement cavity and fixed on two inner side walls of the panel light body and connected with the constant current power supply. A panel light main body screens hole is provided in the panel body. A replaceable frame screens hole is provided at the corresponding position of the replaceable frame.

### TECHNICAL FIELD

The disclosure relates to the panel light, in particular to a replaceable LED panel light which could be replaced simply and quickly.

### BACKGROUND

Conventional Troffer light's base plate is fixed on the ceiling grid, and the lamp panel is secured by a bracket or a fixed frame. On one hand, the taper structure of the lamp panel causes the Troffer light with a small beam angle, an illumination area, and uneven illumination. On the other hand, Troffer volume is large so that the packaging and transportation costs is high. Due to conventional troffer's inherent installation (hanging, embedded, surface mounting etc.), the way of fixed troffer base plate is no adopted, which could not use the original base plate and requires disassembly costs, resulting in waste of resources.

### SUMMARY

The purpose of the disclosure is to provide a Simply and Quickly replaceable LED panel light to solve the problems based on the background described above.

To achieve the above object, the disclosure provides the following technical solutions:

A simply and quickly replaceable LED panel light includes a panel light body, and replaceable frame. The replaceable frame is located below the panel light body, and a fixing group is provided between the replaceable frame and the panel light body. The interior of panel light body has a placement cavity. A back plate, an EVA cotton pad, a reflective paper, a light guide plate, and a diffuser plate are, in turn, provided inside the placement cavity from bottom to top. A constant current power supply is fixed at the inner corner of the placement cavity. Two LED lighting modules are provided inside the placement cavity. The two LED lighting modules are fixed on two inner side walls of the panel light body and connected with the constant current power supply. A panel light main body screens hole is provided in the panel body, and a replaceable frame screens hole is provided at the corresponding position of the replaceable frame. The main body screens hole and the replaceable frame Screens hole is used to install a fixing group. The fixing group includes a rotating fixing piece, a knob supporting frame, a lock body rotating bracket limit post, and a lock body knob fixing member. The rotating fixing piece has a core pulling rivet, and the main body knob supporting frame is provided inside the replaceable outer frame Screens hole. A replaceable outer frame latching hole and a replaceable frame rail slot are provided on the replaceable outer frame. The replacement outer frame Screens hole and the replaceable frame rail groove are located on the same side of the replaceable outer frame. The replaceable frame rail groove has a replacement rail positioning groove. The replaceable frame rail groove and the replacement rail positioning groove form an open sliding space. A screw hole is disposed on both sides of the width direction of the panel light body, and a main body supporting screw is inserted in the screw hole. The diameter of the main body support screw matches the width of the sliding space; a replaceable frame bolt is also inserted in the replaceable outer frame.

The backboard, the EVA cotton pad, the reflective paper, the light guide plate, and the diffusing plate are penetrated and fixed by a plurality of backing plate fastening screws with a rectangular distribution, and the LED light lighting module has a plurality of linearly arranged lamp beads. At the same time, a safety sling is provided at a central position on both sides in the longitudinal direction of the panel lamp body, and a conventional Troffer base plate is also disposed outside the panel lamp body.

The replaceable outer frame has a panel lamp main body frame, and the panel lamp main body frame is of a metal plate, and the cross section of the panel lamp main body frame is larger than that of the panel lamp body. The replaceable outer frame has a LED Panel light main body frame, the panel light main body frame is a metal plate, and the cross-section of the panel light main body frame is larger than the cross section of the panel light body.

Compared with the existing technology, the disclosure has the beneficial effects that the device adopts a fixed group and a rivet column to realize an installation and fixing of the replaceable outer frame. Because the fixing group is installed after the rivet column is fixed, It is quick to install and convenient to the replace and dis-assemble.

### BRIEF DESCRIPTION OF THE DRAWINGS

FIG. 1 is a vertical view of this disclosure;

FIG. 2 is an internal structural explosive view of a LED Panel body in this disclosure;

FIG. 3 is an enlarged view of partial mechanism of LED module in this disclosure;

FIG. 4 is a splitting view of replaceable frame and LED Panel body in this disclosure;

FIG. 5 is a explosive view of fixing group in this disclosure;

FIG. 6 is an assembly diagrammatic view of LED Panel body and replaceable frame;

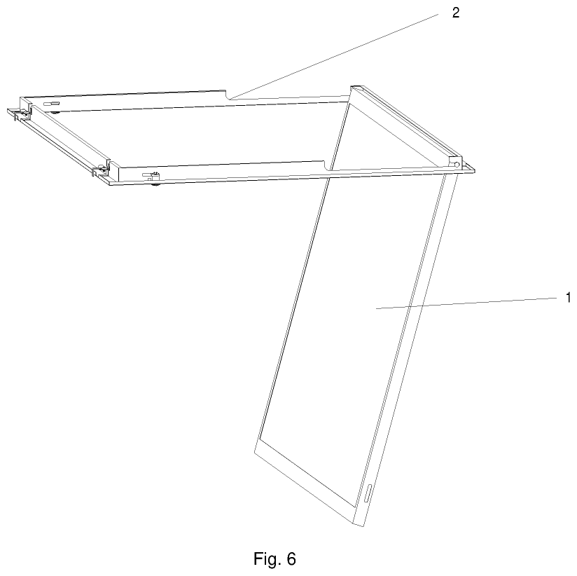

FIG. 7 is a diagrammatic view of LED Panel body, replaceable frame, and traditional Troffer base plate.

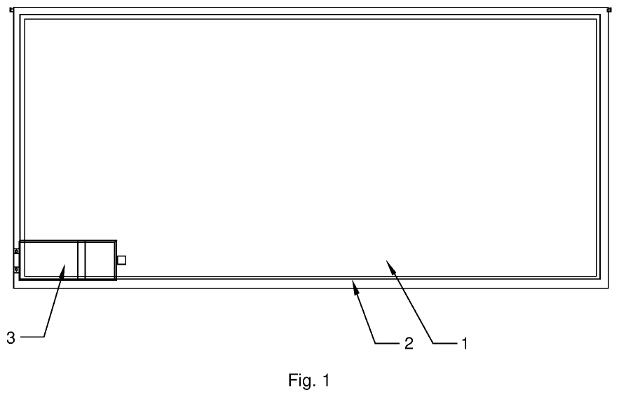

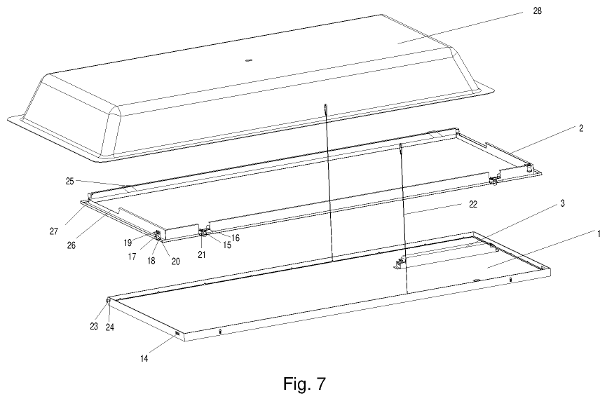

figure 1—led panel lamp body; 2—replaceable outer frame; 3—constant current power supply; 4—back plate; 5—eva pad; 6—refective paper; 7—light guide plate; 8—diffuser plate; 9—led lighting modules; 10—led panel main body frame; 11—back plate fastening screw; 12—lamp bead; 14—main body screens hole; 15—rotatable fixing piece; 16—knob support frame ; 17—lock body rotating bracket limit post; 18—lock body knob fixing piece; 19—replaceable frame screens hole ; 20—locking body rotating supportive bracket; 21—core pulling rivet, safety sling; 23—main body supporting screw; 24—screw hole; 25—replaceable frame latch; 26—replaceable frame rail groove; 27—replacement rail positioning groove; 28—traditional troffer base plate.

### DETAILED DESCRIPTION OF THE EMBODIMENTS

The following will combine with the attached figures of the embodiment in this disclosure, to clearly and completely describe the technical proposal of the embodiment in this disclosure. Obviously, the described embodiment is just a part of this disclosure instead of all embodiments. Based on the embodiments of this disclosure, under the premise of no creative labour, all other embodiments gained by the common technician in this field, belong to the protective scope of this disclosure.

In the description of the disclosure, need be noted that the terms “center”, “up”, “down”, “left”, “right”, “vertical”, “horizontal”, “inside”, “outside”, etc indicating the orientation or positional relationship is based on the orientation or positional relationship shown in the drawings, and is merely for convenience of description of the disclosure and a simplified description, and does not indicate or imply that the device or component must has a specific orientation and be constructed in a specific orientation and operation, therefore, can not be comprehended as limiting of the disclosure. Moreover, the terms “first”, “second”, and “third” are used for descriptive purposes only, and can not be comprehended as indicating or implying the relative importance.

In the description of the disclosure, need be noted that terms “installation”, “connection”, “connection” should be understood broadly, unless there are other definite regulations and restrictions. For example, can be a fixed connection, can also be a detachable connection, or an integrally connection; can be mechanical connection, can also be electrical connection; can be direct connection, can also be indirectly connected through an intermediate medium, can be the internal connection of the two components. The specific meaning of the above terms in the disclosure can be understood in a specific case by ordinary technician in the field.

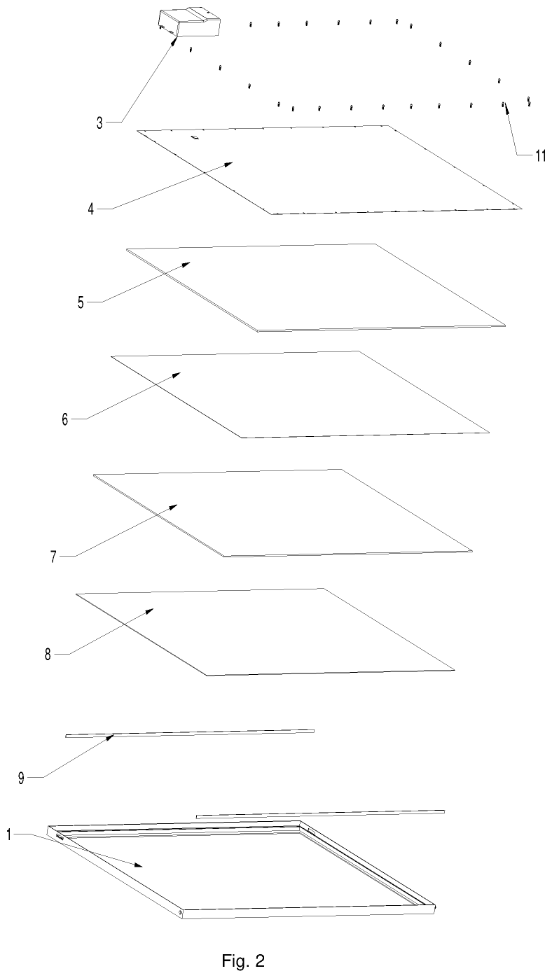

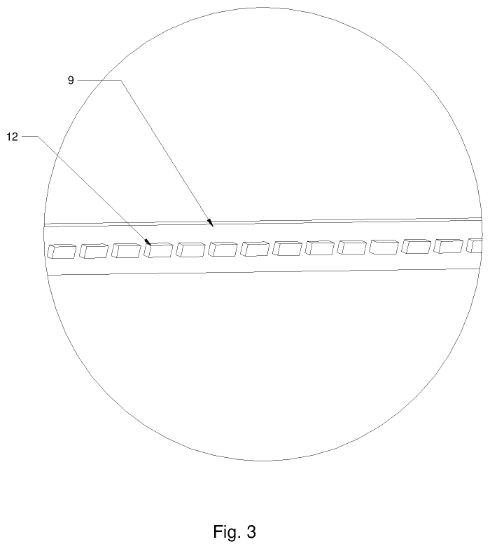

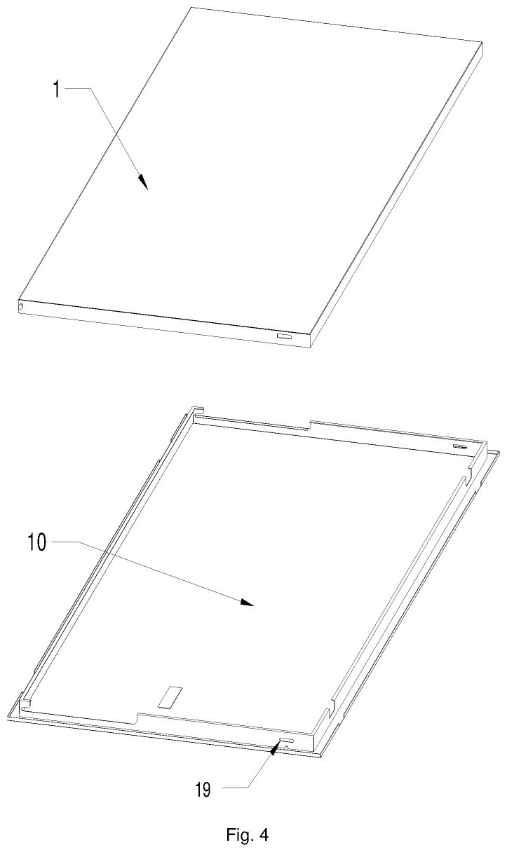

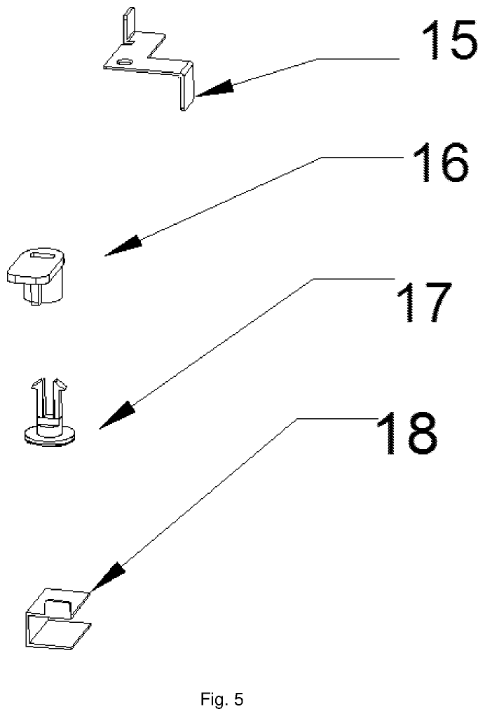

Please refer to the FIGS. 1-5, a simply and quickly replaceable LED panel light includes a panel light body 1, and replaceable frame 2. The replaceable frame 2 is located below the panel light body 1, and a fixing group is provided between the replaceable frame 2 and the panel light body 1. The interior of panel light body 1 has a placement cavity. A back plate 4, an EVA cotton pad 5, a reflective paper 6, a light guide plate 7, and a diffuser plate 8 are, in turn, provided inside the placement cavity from bottom to top. A constant current power supply 3 is fixed at the inner corner of the placement cavity. Two LED lighting modules 9 are provided inside the placement cavity. The two LED lighting modules 9 are fixed on two inner side walls of the panel light body 1 and connected with the constant current power supply 3. A panel light main body screens hole 14 is provided in the panel body 1, and a replaceable frame screens hole 19 is provided at the corresponding position of the replaceable frame 2. The fixing group includes a rotating fixing piece 15, a knob supporting frame 16, a lock body rotating bracket limit post 17, and a lock body knob fixing member 18. The rotating fixing piece 15 has a core pulling rivet 21, and the main body knob supporting frame 19 is provided inside the replaceable outer frame Screens hole 19. A replaceable outer frame latching hole 19 and a replaceable frame rail slot 26 are provided on the replaceable outer frame 2. The replacement outer frame Screens hole 19 and the replaceable frame rail groove 26 are located on the same side of the replaceable outer frame 2. The replaceable frame rail groove 26 has a replacement rail positioning groove 27. The replaceable frame rail groove 26 and the replacement rail positioning groove 27 form an open sliding space. A screw hole 24 is disposed on both sides of the width direction of the panel light body 1, and a main body supporting screw 23 is inserted in the screw hole 24. The diameter of the main body support screw 23 matches the width of the sliding space; a replaceable frame bolt 25 is also inserted in the replaceable outer frame 2.

Specifically, the backboard 4, the EVA cotton pad 5, the reflective paper 6, the light guide plate 7, and the diffusing plate 8 are penetrated and fixed by a plurality of backing plate fastening screws 11 with a rectangular distribution, and the LED light lighting module 9 has a plurality of linearly arranged lamp beads 12. At the same time, a safety sling 22 is provided at a central position on both sides in the longitudinal direction of the panel lamp body 1, and a conventional Troffer base plate 28 is also disposed outside the panel lamp body 1.

Further, the replaceable outer frame 2 has a panel lamp main body frame 10, and the panel lamp main body frame 10 is of a metal plate, and the cross section of the panel lamp main body frame 10 is larger than that of the panel lamp body 1.

In the installation, first, cut off the mains switch, remove the lamp cover on the conventional Troffer base plate 28, slightly raise a side of the conventional Troffer base plate 28, and insert the replaceable frame bolt 25 on the replaceable frame 2 into a gap between the ceiling grid and one side of the Troffer base plate 28, lift the other side of the replaceable frame 2 to make it horizontal. Pull the knob support frame 16 to make it protrude outward, and hang it on the ceiling grid, so that the replaceable frame 2 is hung on the ceiling grid through a latch 25 and the knob support frame 16, and the traditional Troffer base plate 28 is pressed on the replaceable frame 2 to make it unable to move. Then, vertically pick up the panel lamp body 1 to make the main body supporting screw 23 on both sides of the panel lamp body 1 hung on the replaceable frame rail groove 26 of the replaceable outer frame 2, parallelly push the panel lamp main body 1 to make it slide to the replacement rail positioning groove 27, hang the hook of the safety sling 22 on the panel lamp main body 1 on the Troffer base plate 28, and connect the original input power line and the dimming light of the conventional Troffer base plate 28 to the constant current driving power source 3. Finally, push the non-suspended side of the panel lamp body 1 to make it horizontal, rotate the lock body knob fixing member 18 of the replaceable frame 2, and control the lock knob body support frame 20 through the replaceable frame screens hole 19 of the replaceable outer frame 2 and the main body screens hole 14 of the panel lamp body.

It is apparent to those skilled in the art that the present disclosure is not limited to the details of the above-described exemplary embodiments, and the present disclosure can be embodied in other specific forms without departing from the spirit or essential characteristics of the disclosure. Therefore, the present embodiments are to be considered as illustrative and not restrictive, and the scope of the disclosure is defined by the appended claims instead All changes in the meaning and scope of equivalent elements are included in the present disclosure. Any reference signs in the claims should not be construed as limiting the claim.

In addition, it should be understood that although the description is described in terms of embodiments, not every embodiment includes only one independent technical solution. The description of the specification is merely for the sake of clarity, and those skilled in the art should regard the specification as a whole. The technical solutions in the respective embodiments may also be combined as appropriate to form other embodiments that can be understood by those skilled in the art.

What is claimed is:

1. A simply and quickly replaceable LED panel light comprising a panel lamp body (1) and a replaceable outer frame (2), wherein the replaceable outer frame (2) is located below the panel lamp body (1), and a fixed group is provided between the replaceable frame (2) and the panel lamp body (1); the interior of panel lamp body (1) has a placement cavity; a back plate (4), an EVA cotton pad (5), a reflective paper (6), a light guide plate (7), and a diffuser plate (8) are, in turn, provided inside the placement cavity from bottom to top; a constant current power supply (3) is fixed at the inner corner of the placement cavity, two LED lighting modules (9) are provided inside the placement cavity, the two LED lighting modules (9) are fixed on two inner side walls of the panel lamp body (1) and connected with the constant current power supply(3); a panel light main body screens hole (14) is provided in the panel body (1), and a replaceable frame screens hole (19) is provided at the corresponding position of the replaceable frame(2);
the fixing group comprises a rotating fixing piece (15), a knob supporting frame (16), a lock body rotating bracket limit post (17), and a lock body knob fixing member (18); the rotating fixing piece (15) has a core pulling rivet (21), and the main body knob supporting frame (19) is provided inside the replaceable outer frame Screens hole (19); a replaceable outer frame latching hole (19) and a replaceable frame rail slot (26) are provided on the replaceable outer frame (2); the replacement outer frame Screens hole (19) and the replaceable frame rail groove (26) are located on the same side of the replaceable outer frame (2); the replaceable frame rail groove (26) has a replacement rail positioning groove (27); the replaceable frame rail groove (26) and the replacement rail positioning groove (27) form an open sliding space; a screw hole (24) is disposed on both sides of the width direction of the panel light body (1), and a main body supporting screw (23) is inserted in the screw hole (24); the diameter of the main body support screw (23) matches the width of the sliding space.

2. The simply and quickly replaceable LED panel light according to claim 1, wherein a replaceable frame bolt (25) is also inserted in the replaceable outer frame (2).

3. The simply and quickly replaceable LED panel light according to claim 1, wherein the backboard (4), the EVA cotton pad (5), the reflective paper (6), the light guide plate (7), and the diffusing plate (8) are penetrated and fixed by a plurality of backing plate fastening screws (11) with a rectangular distribution, the LED light lighting module (9) has a plurality of linearly arranged lamp beads (12), and a conventional Troffer base plate (28) is also disposed outside the panel lamp body (1).

4. The simply and quickly replaceable LED panel light according to claim 2, wherein the backboard (4), the EVA cotton pad (5), the reflective paper (6), the light guide plate (7), and the diffusing plate (8) are penetrated and fixed by a plurality of backing plate fastening screws (11) with a rectangular distribution, the LED light lighting module (9) has a plurality of linearly arranged lamp beads (12), and a conventional Troffer base plate (28) is also disposed outside the panel lamp body (1).

5. The simply and quickly replaceable LED panel light according to claim 1, wherein a safety sling (22) is provided at a central position on both sides in the longitudinal direction of the panel lamp body (1).

6. The simply and quickly replaceable LED panel light according to claim 2, wherein a safety sling (22) is provided at a central position on both sides in the longitudinal direction of the panel lamp body (1).

7. The simply and quickly replaceable LED panel light according to claim 1, wherein the replaceable outer frame (2) has a panel lamp main body frame (10), and the panel lamp main body frame (10) is of a metal plate.

8. The simply and quickly replaceable LED panel light according to claim 2, wherein the replaceable outer frame (2) has a panel lamp main body frame (10), and the panel lamp main body frame (10) is of a metal plate.

9. The simply and quickly replaceable LED panel light according to claim 7, wherein the cross section of the panel lamp main body frame (10) is larger than that of the panel lamp body (1).

10. The simply and quickly replaceable LED panel light according to claim 8, wherein the cross section of the panel lamp main body frame (10) is larger than that of the panel lamp body (1).
